(19) United States
(12) Patent Application Publication
(10) Pub. No.: US 2006/0090017 A1
(43) Pub. Date: Apr. 27, 2006

(54) Microprocessor system with memory device including a DMAC, and a bus for DMA transfer of data between memory devices

(75) Inventors: Siyoung Kim, Seoul (KR); Kyungwoo Nam, Seoul (KR); Myung-Gyoo Won, Hwasung-City (KR); Yunsoo Lee, Seoul (KR); Jongwon Lee, Seoul (KR); Yanghoon Jung, Suwon-City (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/141,091

(22) Filed: May 31, 2005

(30) Foreign Application Priority Data
Oct. 25, 2004 (KR) 2004-85255

(51) Int. Cl. G06F 13/28

(52) U.S. Cl. 710/22

(57) ABSTRACT

A processor system having a memory device including a (RAM) memory and a direct memory access controller (DMAC) and an internal bus switchably connected between the memory and the DMAC. A Bus Switch (multiplexer) within the memory device alternately establishes a first data transmission path over the system bus between the memory and an external processor, and a second data transmission path over the internal bus between the memory and the DMAC. The first data transmission path, when established through the Bus Switch, supports random access of the memory by the external processor. The second data transmission path, when established through the Bus Switch, supports a Direct Memory Access (DMA) between the RAM and an external storage device, e.g., a Nonvolatile Memory (NVM), connected to the DMAC while the processor has full and exclusive use of the system bus.

### TECHNICAL FIELD

The present invention relates to methods and circuits for direct memory access (DMA) of data between system memory (RAM) and a nonvolatile memory (NVM) in a microprocessor system.

### DISCUSSION OF RELATED ART

Advances in technology, particularly in digital cell-phones, digital cameras, and MP3 players etc., have created demand for the ability to transfer large amounts of data such as image and sound data with extremely high speed between its embedded microprocessor and a Random Access Memory (RAM) to or from a storage unit such as a nonvolatile memory (NVM), for example a Flash Memory card. Non-volatile memory (NVM) will store its contents even when it is powered down.

Flash Memory technology has been optimized to meet the needs of portable and embedded devices and support embedded code storage and bulk data storage applications. NAND Flash is a sequential access device appropriate for mass storage applications, while NOR Flash is a random access device more applicable for code storage applications. NAND Flash technology organizes its memory cells serially to achieve higher densities. This reduces the number of external contacts needed to access the memory array. NAND Flash data must be accessed sequentially (compared with NOR Flash which offers fast random parallel access). NAND Flash memory is ideal for applications ranging from MP3 players and digital cameras to applications requiring mass storage of data, especially when the (image) data is packetized, or sequentially arranged.

In early computer system designs, the transfer of information between system memory (RAM) and input-output (I/O) addressable peripheral devices such as disk controllers, displays, keyboards and serial or parallel interface units was performed directly by the system microprocessor. As the number of transactions with peripheral devices increased and the capabilities of such devices expanded, the burden on the microprocessor associated with this transfer task severely limited overall system performance. Thus originally data transfer was carried out under the control of the microprocessor (e.g., central processing unit, hereafter simply referred to as CPU) provided in the data processing circuit. Therefore, the process speed of the conventional data transfer would depend on the processing speed of the CPU and it would be impossible to transfer data at a speed in excess of the processing speed of the CPU. Further, the processor becomes unavailable during such a transfer of a large amount of data.

Accordingly, techniques were developed to free the microprocessor from the task of transferring data from the system memory. Direct memory access (DMA) was one such developed technique. A direct memory access (DMA) transfer enables the transfer of data between the data processing system and the external storage unit without using the CPU.

FIG. 1 is a circuit block diagram of a conventional microprocessor (e.g., System on a Chip, SoC) system 100 having a direct memory access controller (DMAC) 140. The DMA controller (DMAC) 140 which controls the DMA transfer is intended to effectively process a large amount of data at a high-speed between the system memory (RAM) 120 and a Nonvolatile Memory (NVM) 130, without continuously using the SoC Processor 110. The DMAC 140 is operatively connected to and uses two data paths (e.g., buses) 150 and 160 to transfer the data between the system memory (RAM) 120 and the Nonvolatile Memory (NVM) 130. The first data path 150 operatively connected to the DMAC is the processor's system bus, which is connected between the processor circuit (not explicitly shown) and the (external) memory (RAM) 120. The second data path 160 operatively connected to the DMAC is extended to operatively connect with the external Nonvolatile Memory (NVM) 130. In the case of a NAND NVM, the second path 160 may be a serial bus line having fewer parallel conductors than the first data path (the processor's system bus) 150.

Direct memory access is typically handled by a DMA controller (DMAC) 140 which is assigned the task of coordinating and performing data transfers between system memory (120) and a peripheral device (e.g., NVM 130, or other system resource) without the use and intervention of the microprocessor (e.g., CPU, 110). Generally, in the DMA controller (DMAC) 140, data is transferred in accordance with descriptors (transfer control information, also called “initialization data”) necessary for the DMA transfer. Descriptors include a source address, a destination address, and a byte count (the number of bytes of data to be transferred), to indicate: the direction of the transfer to be executed (i.e., memory-to-peripheral device or peripheral device-to-memory); the first address of system memory from which data is to be retrieved or to which data is to be written; and the number of data words or bytes involved in the desired DMA transfer operation.

Following initialization, the peripheral device (or peripheral controller), e.g., NVM 130, can initiate the DMA transfer at any time by asserting a request signal to indicate that it is ready to receive or transmit data via a direct memory access operation. The DMA controller DMAC 140 responsively obtains mastership of the processor's system bus by asserting a bus request signal (referred to as a “HOLD” signal for some microprocessors). When the microprocessor detects assertion of the bus request signal, it completes the operation it is currently executing, disables its address, data, and control bus outputs, and asserts a bus acknowledge signal. The DMA controller (DMAC 140) then takes control of the local bus (i.e., the processor's system bus) to perform the transfer.

In the conventional DMA transfer, (in the register direct mode), when a request for the DMA transfer occurs, the CPU (e.g., SoC processor 110) releases a system bus from its exclusive use, and then the DMA controller carries out the DMA transfer while exclusively using the system bus. At this time, various internal processing modes are processed in the DMAC (this is called an internal process). For example, the DMA controller sets transfer control information which includes the source address, destination address and the byte count in internal registers. Then, after executing a predetermined error test, the DMA controller starts the data transfer based on the DMA transfer.

Generally, the DMA controller is provided with a plurality of channels (e.g., Ch1, Ch2, Ch3 . . . ) in order to cope with a plurality of requests of the DMA transfer. A channel is defined as a transfer path between a device and a memory, or a transfer path between memories. In a conventional DMA transfer, all transfer paths physically pass though the processor's system bus. For example, a four-channel DMA controller is a DMA controller such that data transfers through four transfer paths are simultaneously controlled. For example, image data for use in a video display may be transferred through a first channel, while received image data may transferred through one of the other channels. Of course, because all transfer paths physically pass through the processor's system bus, a plurality of data transfers cannot be made with respect to the system bus at exactly the same time. Therefore, when two or more data transfers are requested at the same time, data relating to each of the requested channels is segmented into a plurality of unit-length data, which are alternately transferred (time-multiplexed) by switching the channels. Thereby, the data transfers through a plurality of channels are carried out at roughly the same time, through the processor's system bus in a time-multiplexed manner. Meanwhile, during any such DMA data transfers, the processor's system bus is unavailable to the processor.

During a conventional DMA data transmission, the processor's system bus is filled with data being transferred, thereby delaying the operation of the processor or consuming power due to continuous idle operation of the processor waiting for control of the processor's system bus.

### SUMMARY OF THE INVENTION

The embodiments of the present invention effect realization that some Data (e.g., image data) in the processor's system memory (e.g., RAM) can and should pass directly to a Nonvolatile Memory (NVM), and vice versa, under the control of a DMA controller (DMAC) but without using and tying up the processor's system bus. By providing a switchably accessible second physical bus internal within the memory device, referred to herein as a “memory internal bus” or “internal bus” (e.g., between a Bus switch and the DMAC), and by providing a bidirectional Bus switch (or a bus multiplexer herein referred to as a MUX) connecting the memory (RAM) alternately to each physical bus, Data can be directly transmitted between the (RAM) memory and the NonVolatile Memory (NVM) without using the processor's system bus, thereby increasing performance, and reducing power consumption, since the processor can meanwhile be independently operated or idled with full control and use of its system bus. And, the data transmission rate between the memory (RAM) and the DMAC is faster than in the conventional system of FIG. 1, because both are in the same memory device.

An embodiment of the present invention provides a memory device comprising: a memory (RAM); a direct memory access controller (DMAC); a Internal Bus; and a Bus Switch (e.g., a bus multiplexer); wherein the Bus Switch alternately establishes a first data transmission path (over a system bus between the RAM and an external processor) and a second data transmission path (over the Internal Bus between the RAM and the DMAC). The first data transmission path established through the Bus Switch supports random access, by the external processor, of Data stored or to be stored in the RAM. The second data transmission path established through the Bus Switch supports a Direct Memory Access between the RAM and an external storage device, e.g., Nonvolatile Memory (NVM), connected to the DMAC (e.g., while the processor has full and exclusive use of the system bus).

Another embodiment of the present invention provides a processor system, comprising: a CPU Core; a system bus of the CPU Core; a direct memory access controller (DMAC); and at least one (e.g., first) bus switch connected to the system bus. The first bus switch is for alternately establishing a first data transmission path between an external memory and the CPU core, and a second data transmission path between the memory and the DMAC. The first data transmission path supports a random access, by the CPU Core, of the memory. The second data transmission path supports a direct memory access, performed by the DMAC, of the memory. The first bus switch may be further adapted to establish a third data transmission path supporting a transfer of data between the CPU Core and the DMAC, and wherein the third data transmission path includes system bus of the CPU Core.

Another embodiment of the present invention provides a memory device, comprising: a RAM; a DMAC operatively connected to a first data path, and a second data path; wherein the first data path is further connected to access the RAM, and the second data path is further connected to access an external nonvolatile memory. The memory device further comprises a third data path that connects an external processor to access the RAM. The third data path that connects the external processor to access the RAM may be operatively connected to the DMAC.

Still another embodiment of the invention provides an apparatus comprising: a processor, a RAM, a direct memory access controller (DMAC), and a nonvolatile memory, wherein the DMAC controls data access from the RAM to the processor through a first data path and data access from the nonvolatile memory to the processor through (a portion of) the first data path. The DMAC may be advantageously disposed within a RAM device containing a RAM. The apparatus may further include a first control path that facilitates transfer of control data between the DMAC and the processor. The apparatus may further include an arbiter that arbitrates processor access to the RAM or to the nonvolatile memory.

The DMAC may include a buffer that buffers data accessed from the RAM or the nonvolatile memory. The apparatus may further including a (bus) multiplexer that multiplexes access to the RAM between the processor (through the first data path) and the nonvolatile memory (through the third data path). The apparatus may further include a first interface that interfaces between the DMAC is and the nonvolatile memory and a second interface that interfaces between the DMAC and the RAM. A data path between the nonvolatile memory (NVM, e.g., flash memory) and the RAM may include the first interface, the buffer, and the second interface. Data accessed from the nonvolatile memory (NVM) and stored in the RAM may be retrieved by the processor from the RAM. The apparatus may further include an input/output buffer that buffers input and output data from and to the processor.

A method is also provided for accessing memory in an apparatus having: a processor, a memory (RAM), a direct memory access controller (DMAC), and a nonvolatile memory (NVM). The method comprises controlling data accesses with the DMAC to alternately access data, from the RAM to the processor through a first data path, and from the nonvolatile memory to the processor through (a portion of) the first data path. The DMAC and the RAM may be disposed within a memory device. The method may further include arbitrating with an arbiter the access to the RAM or the access to the nonvolatile memory (NVM). The method may further include buffering, with a buffer, data accessed from the RAM or from the nonvolatile memory. The method my further include multiplexing with a (bus) multiplexer access to the RAM between the first data path and a third data path. The method may further include interfacing (with a first interface) the DMAC and the nonvolatile memory (NVM), and interfacing (with a second interface) between the DMAC and RAM. The method may further include selecting a data path between the nonvolatile memory (NVM) and the RAM through the first interface, the buffer, and the second interface. The data accessed from the nonvolatile memory (NVM) may be stored in the RAM and the data may then be retrieved by the processor from the RAM. The method may further include buffering, with a buffer, input and output data from and to the processor. The RAM is may be one of a Dynamic Random Access Memory (DRAM) and a Static Random Access Memory (SRAM). The nonvolatile memory (NVM) may be a flash memory.

### BRIEF DESCRIPTION OF THE DRAWINGS

The present invention will become understood by those of ordinary skill in the art by describing, in detail, exemplary embodiments thereof with reference to the attached drawings. In FIGS. 4, 5 and 6, the repeating symbols A and B refer to sequentially written buffered data from two buffers (in the DMAC 320); and the symbols “clk” (e.g., 1 clk) and capital T (e.g., TA, TB, T3) refer to units of time (e.g., clk1 denotes one period of the data clock, and TA, TB etc. each denote time periods equal to a multiple of the period of the data clock), rather than element references. In the drawings, like elements are represented by like reference numerals. The drawings are provided for illustration only and do not limit the scope of the present invention:

FIG. 1 is a circuit block diagram illustrating a conventional processor system, including a nonvolatile memory and a direct memory access controller;

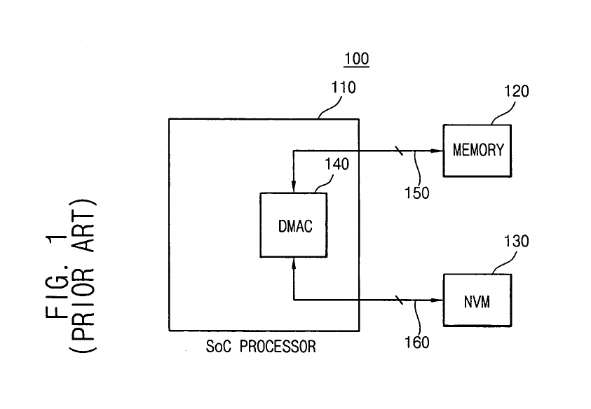

FIG. 2A is a circuit block diagram illustrating a processor system including a memory device having an internal bus, switchably connected (by a bus multiplexer) between a system memory (RAM) and a direct memory access controller, according to an embodiment of the present invention;

FIG. 2B is a circuit block diagram illustrating a processor system including a memory device having an internal bus, switchably connected (by a bus multiplexer) between a system memory (RAM) and a direct memory access controller, according to another embodiment of the present invention;

FIG. 3A is a functional block diagram illustrating a memory device including a memory (RAM) switchably connected (by a pair of bus multiplexers) to an external processor and to a direct memory access controller (DMAC) according to another embodiment of the present invention;

FIG. 3B is a functional block diagram illustrating a memory device including a memory (RAM) switchably connected to an external processor and to a direct memory access controller (DMAC) according to another embodiment of the present invention.

FIG. 4 is a timing diagram of signals of the direct memory access controller in FIG. 2A illustrating data transmission, through the internal bus and the DMAC, from the external (NVM) memory to the system memory;

FIG. 5 is a timing diagram showing a plurality of signals of the direct memory access controller in FIG. 2A, illustrating arbitration methods for transmission of data from the external (NVM) memory through the DMAC to the system memory;

FIG. 6 is a timing diagram showing a plurality of signals of the direct memory access controller in FIG. 2A, illustrating arbitration methods for alternately accessing the system memory from the processor and from the DMAC; and

FIG. 7 is a circuit block diagram illustrating a processor system including a processor and a direct memory access controller (DMAC), switchably connected (by a bus router) to a system memory (RAM) and to a non volatile memory (NVM), according to another embodiment of the present invention;

### DETAILED DESCRIPTION OF THE EXEMPLARY EMBODIMENTS

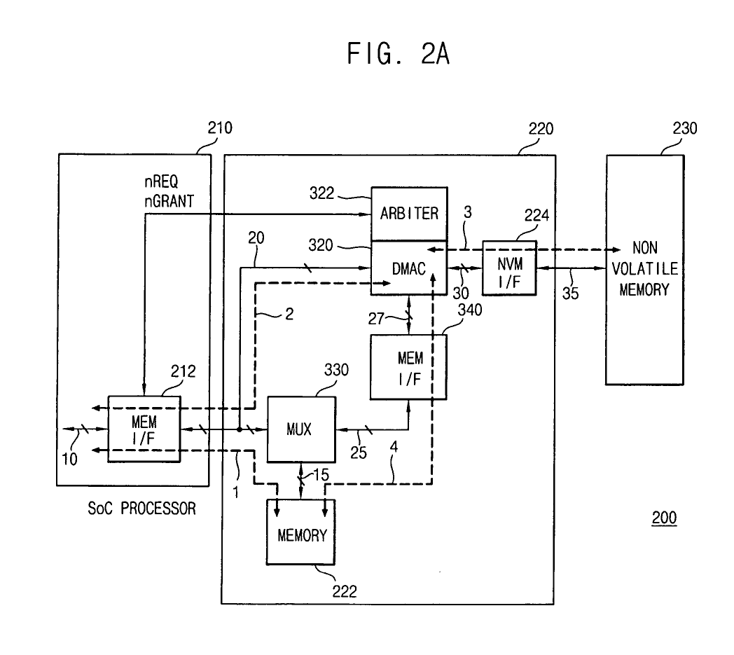

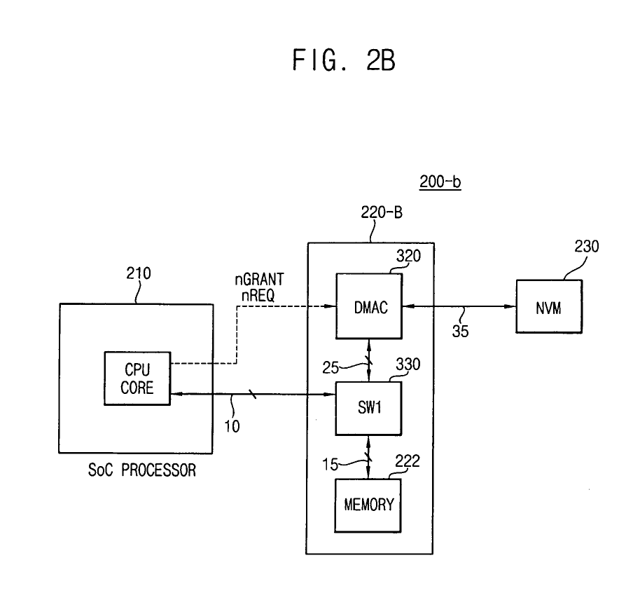

FIG. 2A is a circuit block diagram illustrating a processor system 200 including a memory device 220 having an internal (memory) bus 25, switchably connected (by a bus multiplexer 330) between a system memory (RAM) 222 and a direct memory access controller (DMAC 320), according to an embodiment of the present invention. The processor system 200 generally includes a “system-on-a-chip (SoC) processor 210, a memory device 220 (including a DMAC 320 with an Arbiter 322, and a bus multiplexer MUX 330), and an (external) nonvolatile memory (NVM) 230. The memory 222 may include synchronous DRAM cells or SRAM cells.

FIG. 2A additionally depicts, by dotted lines, the data routes (data transmission paths 1, 2, 3, & 4) by which data may be transmitted to, from, and between the processor 210, the DMAC 320, the memory RAM 222 and the external nonvolatile memory NVM 230.

As depicted in FIG. 2A, data may be transmitted (e.g., written from the processor 210 into the system memory 222, or read by the processor 210 from the system memory 222) between the processor 210 and the system memory 222 through data route 1, while the Bus Switch (bus multiplexer 330) is operatively connecting the system's bus (e.g., 10 and 20) to the memory local bus 15. On the other hand, when the Bus Switch (bus multiplexer 330) is instead operatively connecting the memory local bus 15 to the memory internal bus (25), data route 4 may be employed and the memory 222 and the memory local bus 15 are operatively isolated from the processor 210 and from the system's bus (e.g., 10 and 20).

The internal (memory) bus 25 disposed and switchably connected by the bus switch (bus multiplexer MUX 330) between the system memory (RAM) 222 and the DMAC 320, enables the transmission of data (e.g., by and through the DMAC 320, over data routes 3 and 4) between the system memory (RAM 222) and the (external) nonvolatile memory NVM 230 without using or tying up the processor's system bus (e.g., 10, 20). Thus, power consumption may be reduced since the processor 210 (and its system bus, 10, 20) can meanwhile be 5 independently operated.

The arbiter 322 controls data transmission between the processor 210 and the memory 222 (via data route 1), between the processor 210 and the DMAC 320 (via data route 2), and between the DMAC 320 and the memory 222 (via data route 4). The arbiter 322 does not directly control the data transmission between the lo DMAC 320 and the nonvolatile memory NVM 230, but its operations may affect data transmission (via data route 3) between DMAC 320 and the nonvolatile memory NVM 230. More particularly, the role of the arbiter 322 is to select at which times data transmission shall be performed over data route 1 (between the processor 210 and the memory 222), or over data routes 2 and 3 (between the 15 processor 210 and the NVM 230 via the DMAC 320), or over data routes 4 and 3 (DMA between the NVM 230 and the memory 222 via the DMAC 320). The arbiter 322 generally receives a request signal (nREQ) from the processor 210 and sends a grant signal (nGRANT) to the processor 210. When the processor 210 needs to access the memory 222, the processor 210 sends an active (“Low”) 20 request signal (nREQ) to the arbiter 322. When the arbiter 322 grants the processor 210 access to the memory 222, the arbiter 322 sends an active (“Low”) grant signal (nGRANT) to the processor 210.

### Data Transmission Summary

Data route “1” transmission (Processor 210-Memory 222) can be performed when the processor 210 receives an active (“Low”) grant signal (nGRANT) from the arbiter 322, and the processor 210) generates a first chip selection signal (nCS0);

Data route “2” transmission (Processor 210-DMAC 230) can be performed when the processor 210 receives an active (“Low”) grant signal (nGRANT) from the arbiter 322 and the processor 210) generates a second chip selection signal (nCS1);

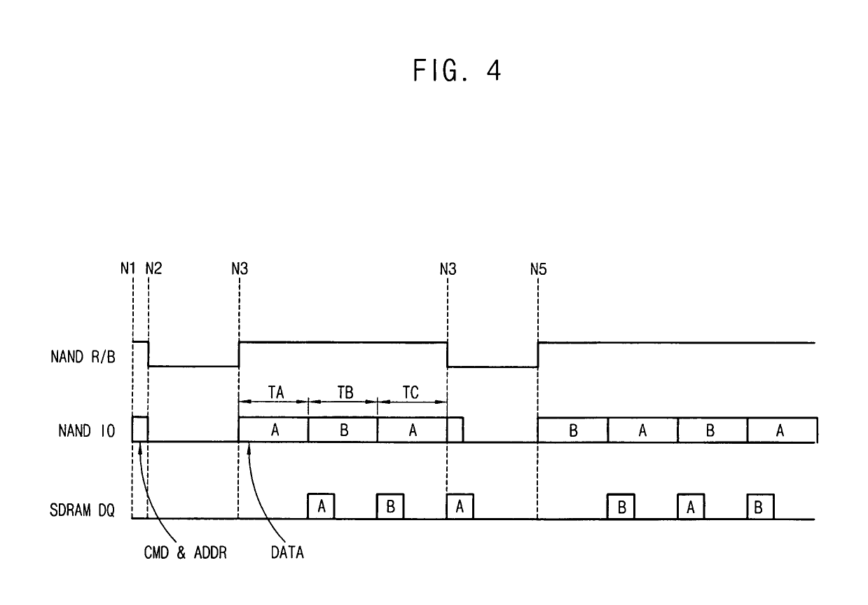

Data route “3” transmission (DMAC 320-NVM 230) can be performed when the NVM is “Ready” (see FIG. 4) (the arbiter 322 does not directly control the data transmission between DMAC and NVM). While the processor 210 accesses the memory 222 (via data route 1), the NVM 230 may send its data to the register 324 of the DMAC 320 (via data route 3);

Data route “4” transmission (DMAC 320-Memory 222) can be commenced while the processor 210 receives an inactive (“High”) grant signal (nGRANT) from the arbiter 322 after the request signal nREQ from the processor is changed to an inactive (“High”) state, and the DMAC generates the third chip selection signal (nCS2) signal.

The processor system 200 may further include one or more interface (I/F) circuits disposed in the data routes between the processor 210, the DMAC 320, the memory RAM 222 and the external nonvolatile memory NVM 230. A first memory interface circuit (MEM I/F) 212 is disposed in data routes 1 and 2 between system bus 10 and system bus extension 20. A second memory interface circuit (MEM I/F) 340 is disposed in data route 4 between the memory internal bus 25 and memory internal bus extension 27. If a NAND (serial) type nonvolatile memory NVM 230 is employed, a nonvolatile memory interface circuit (NVM I/F) 224 may include a serial-to-parallel converter and a parallel to serial converter.

One or more of the interface circuits (212, 340, 224) may include a FIFO (First In First Out) circuit, which is a type of buffer, where the first byte to arrive is the first to leave. FIFO is typically used for data buffering in various computer and communication interfacing applications. FIFOs can be put into two categories: synchronous and asynchronous. A synchronous FIFO has a single clock that governs both reads and writes, while an asynchronous FIFO has separate clocks for the read and write ports. FIFOs are typically reduce the chances of data loss in data communications by ‘buffering’ the data. This way the device driver can then read all of the data from the FIFO in one go, whilst communication is still continuing filling more data to the FIFO.

In at least one embodiment of the invention, the Bus Switch (bus multiplexer 330) can be implemented by a gang of parallel double-throw switches, or the functional equivalent (e.g., low-impedance semiconductor bidirectional pass-gates), micromechanical switches, etc.

In other embodiments of the invention (see e.g., FIG. 2B), the spur of bus 20 connecting with the DMAC 320 can be eliminated or unused for data transmission, and data route 2 shown in FIG. 2A can be remapped through the Bus Switch (330) so as to pass data from bus 10 to bus 20 to bus 25 to bus 27 to the DMAC 320 when the Bus Switch is adapted to operatively connect those busses into one continuous data transmission path.

FIG. 2B is a circuit block diagram illustrating a processor system 200-B including a memory device 220-B having an internal bus 25, switchably connected (by a bus switch SW1) between a system memory (RAM) and a direct memory access controller, according to another embodiment of the present invention. The memory device 220-B of FIG. 2B is similar to the memory device 220 of FIG. 2A except that there is no spur of the system bus 10 hardwire connecting the CPU core of the processor 210 to the DMAC 320.

During a DMA data transfer performed by the DMAC 320 between the non volatile memory (NVM 230) and the system memory (RAM 222), the bus switches SW1 may be configured to disconnect (isolate) the system bus 10 of the processor CPU core from the bus 15 of the memory (RAM 222). During the DMA data transfer performed by the DMAC 320 between the non volatile memory (NVM 230) and the system memory (RAM 222), bus switch SOL will be configured to operatively connect a first bus of the DMAC to the bus 15 of the memory (RAM 222); while the non volatile memory (NVM 230) is operatively connected to the DMAC without an intervening bus switch. In this manner, a DMA transfer of data between the NVM and the memory (RAM 222), or vice versa, may be performed without using or tying up the system bus 10 of the processor CPU Core.

During a random access, by the processor CPU Core, of the system memory (RAM 222), the first bus switch SW1 will be configured to operatively connect system bus 10 of the processor CPU Core to the bus 15 of the memory (RAM 222); and, the first bus switch SOL may be configured to disconnect the bus 25 of the DMAC 320 from the bus 15 of the memory (RAM 222).

In this embodiment of the invention, the first bus switch SW1 will be configurable to operatively connect the system bus 10 of the processor CPU Core to the bus 15 of the memory (RAM 222); and to operatively connect the bus 25 of the DMAC 320 to the bus 15 of the memory (RAM 222). In this embodiment, the first bus switch SW1 may also be configurable to operatively connect the system bus 10 of the processor CPU Core to the bus 25 of the DMAC 320.

For example, while the first bus switch SW1 operatively connects the CPU Core with the bus 15 of the memory (RAM 222) (to support a random access) meanwhile, the DMAC 320 may be transferring data to or from the non volatile memory (NVM 230).

For another example, while the first bus switch SW1 operatively connects the CPU Core with the DMAC 320, the DMAC 320 may be transferring data to or from the non volatile memory (NVM 230). Such a configuration of the switches SW1 would support data transfer between the CPU Core and the non volatile memory NVM 230 (through the DMAC 320).

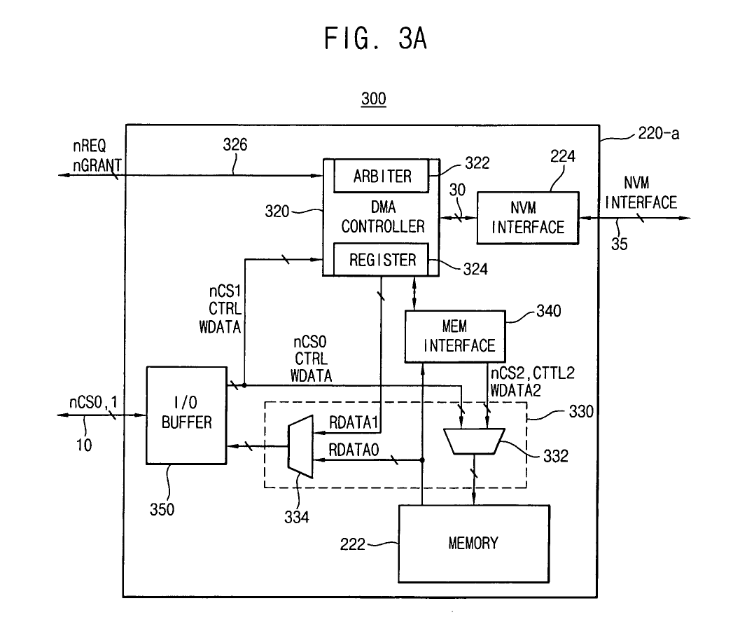

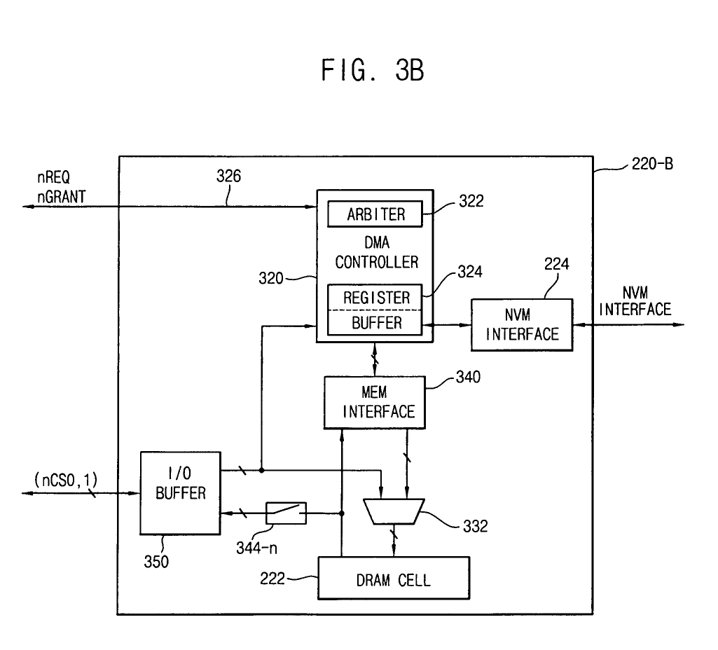

FIG. 3A is a functional block diagram illustrating a memory device 220-a including a memory (RAM) 222 switchably connected (through a pair of bus multiplexers) alternately to an external processor (not shown, see FIG. 2A) and to a direct memory access controller DMAC 320 according to an embodiment of the present invention.

Memory device 220-a includes: a Bus Multiplexer 330 comprised of two (unidirectional) multiplexers (332, 334) and an Input/Output buffer 350. The Input/Output (I/O) buffer 350 may include a FIFO (First In First Out) circuit and may be operatively connected to the processor system bus 10.

The DMAC 320 includes an arbiter (322) to control data transmission to and from the memory 222, and a register 324 to handle data received from the NVM 230. To enable data route “1” transmission (Processor 210-Memory 222), signal lines nCS0, CTRL, WDATA, and RDATA0 are used (e.g., when the processor 210 receives an active grant signal nGRANT from the arbiter 322, the processor 210 generates a first chip selection signal (nCS0) for transceiving data between the processor 210 and the memory 222); To enable data route “2” transmission (Processor 210-DMAC 230), signal lines nCS1, CTRL, WDATA, and RDATA1 are used (e.g., when the processor 210 receives an active grant signal nGRANT from the arbiter 322) (e.g., when the processor 210 receives an active grant signal nGRANT from the arbiter 322, the processor 210 generates a second chip selection signal (nCS1) for transceiving data between the processor 210 and the DMAC 320); To enable data route “3” transmission (DMAC 320-NVM 230), data are transmitted and received via the NVM I/F circuit 224 (The arbiter 322 does not control the transceiving between the DMAC and NVM); To enable data route “4” transmission (DMAC 320-Memory 222), signal lines nCS2, CTRL2, WDATA2, and RDATA0 are used (e.g., when the processor 210 receives an active grant signal nGRANT from the arbiter 322 and the DMAC 320 generates the third chip selection signal (nCS2) signal.

The Register 324 in DMAC 320 includes two buffers (buffer “A” and buffer “B”, not shown) the size of each register buffer is 16 bytes. The buffers are alternately filled with data received from the NVM 230 via the NVM I/F circuit 224. While one buffer (e.g., buffer B) is being filled with data from the NVM 230, the data stored in the other buffer (e.g., buffer A, which was previously filled with data) can be written to the memory 222 (via data route 4), while the processor 210 is not accessing the memory 222. Next, (when the processor 210 is not accessing the memory 222) the other buffer (e.g., buffer A) is being filled with data from the NVM 230, while the data stored in the one buffer (e.g., buffer B, which was previously filled with data) can be written to the memory 222 (via data route 4).

FIG. 3B is a functional block diagram illustrating a memory device including a memory (RAM) switchably connected to an external processor (not shown) and to a direct memory access controller (DMAC) according to another embodiment of the present invention.

Memory device 220-B includes: a Bus Isolator 334-n comprised of a switch and a (unidirectional) Bus multiplexer (332)) and an Input/Output buffer 350, etc.

The DMAC 320 includes an arbiter (322) to control data transmission to and from the memory 222, and a register 324 (including buffers) to handle data received from the NVM 230. To enable data route “1” transmission (random access by the Processor 210 of Memory 222), the Bus Switch 334-n is closed and signal lines nCS0, CTRL, WDATA and, RDATA0 are used (e.g., when the processor 210 receives an active grant signal nGRANT from the arbiter 322, the processor 210 generates a first chip selection signal (nCS0) for transceiving data between the processor 210 and the memory 222) as in FIG. 3A.

The Register 324 in DMAC 320 includes one or more buffers (e.g., buffer “A” and buffer “B” as in FIG. 3A).

FIG. 4 is a timing diagram of signals of the direct memory access controller DMAC 320 in FIG. 2A, illustrating (route 3 & 4) data transmission, through the internal bus 25 and through the DMAC 320, from the external NAND (NVM) memory 230 to the system memory 222 (e.g., DRAM cell). The “NAND R/B” signal indicates whether the NAND type NVM 230 is in a “Ready” state (i.e., ready for data transmission) or instead in a “Busy” state (i.e., “not ready” for data transmission). The “NAND 10” time line in FIG. 4 indicates the specific type of data being transmitted, e.g., Command & Address (CMD & ADDR), or “A” Data (data written to buffer A) or “B” Data (data written to buffer B), to the DMAC 320 (via data route 3). The “SDRAM DQ” time line in FIG. 4 indicates the transmission of A or B data from the DMAC to the memory 222 (via data route 4).

As shown in FIG. 4, data is transmitted from the NVM 230 to the Register (buffers A and B) 324 in the DMAC 320 continuously but into alternating buffers (A and B) while “NAND R/B” signal indicates whether the NAND type NVM 230 is in a “Ready” state (ready for data transmission). And, the buffered data that was transmitted from the NVM 230 to the Register (buffers A and B) 324 can afterwards be sequentially written to the memory 222 (SDRAM DQ) even after the NVM leaves the “Ready” state and enters the “Busy” state. And, the transmission of data from the NVM 230 to the Register (buffers A and B) 324 in the DMAC 320 resumes after an interruption, when the NVM returns to the “Ready” state. Thus, the transmission of data from the NVM 230 to the Register (buffers A and B) 324 in the DMAC 320 is interruptable. And, the transmission of data from the DMAC 320 to the memory 222 is intermittent, and interruptable, allowing for intermittent or sustained accesses of the memory 222 by the processor 210. The transmission of data from the NVM 230 to fill each one of buffers A and B in the DMAC 320 takes place within time period of TA, or TB, respectively, (e.g., TA equals TB).

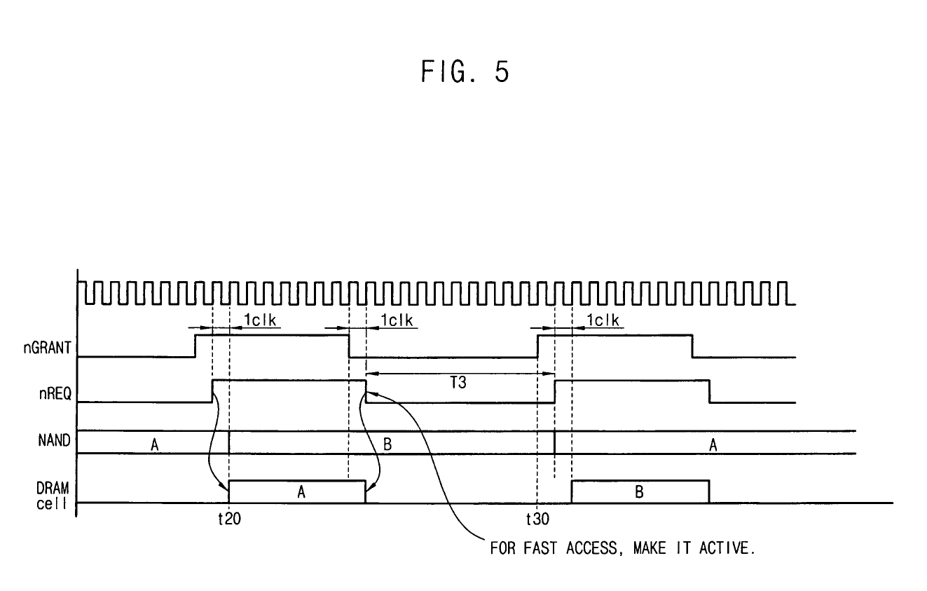

FIG. 5 is a timing diagram showing a plurality of signals of the direct memory access controller DMAC 320 in FIG. 2A, illustrating arbitration methods for transmission of data (via data routes 3 & 4) from the external (NVM) memory through the DMAC to the system memory (in the absence of data accesses by the processor).

As previously explained, data from the data transmitted (via data route 3) from the NVM 230 to the DMAC 320 is alternately stored in buffers A and B in the Register 324 (see FIG. 2A), and is alternately transmitted as Data A and Data B from the DMAC to the memory 222 when the processor is not accessing the memory.

When (e.g., at and after time t20) the DMAC's nGRANT signal goes inactive (“High”), and when the processor's request signal (nREQ) is changed to an inactive (“High”) state, the buffered data (e.g., A) in the register 324 (received from the “NAND” NVM 230) can be transmitted to the memory 222 beginning one clock period after the change to the inactive (“High”) state of the nREQ signal. If the nREQ is changed to an active state (“Low”), the data transmission (e.g., of buffer A data) to the memory 222 from the register 324 is stopped (e.g., for a period of T3).

Next, following time period T3, (e.g., at and after time t30) when the request signal (nREQ) is changed to an inactive (“High”) state again, the next buffered data (e.g., B) in the register 324 is transmitted to the memory 222 beginning one clock after the change to the inactive (“High”) state of the nREQ signal. If the nREQ is changed to an active state (“Low”), the data transmission (e.g., of buffer B data) to the memory 222 from the register 324 is stopped (e.g., for a period of T3). If the nREQ is not immediately changed to an active state (“Low”), the transmission of buffered data (e.g., from buffer A, then from buffer B, then from buffer A, etc) to the memory 222 from the register 324 continues as illustrated in FIG. 4 (e.g., until the nREQ is changed to an active (“Low”) state).

As Illustrated in FIG. 5, the processor has a priority for accessing the memory 222, and so even while (e.g., at one clock after time t30) buffer B in the DMAC 320 is filled (with “NAND” NVM data) and is otherwise ready to be transmitted to the memory 222, that transmission (of buffer B data) to the memory 222 waits until after the processor changes its nREQ signal to an inactive state (“High”).

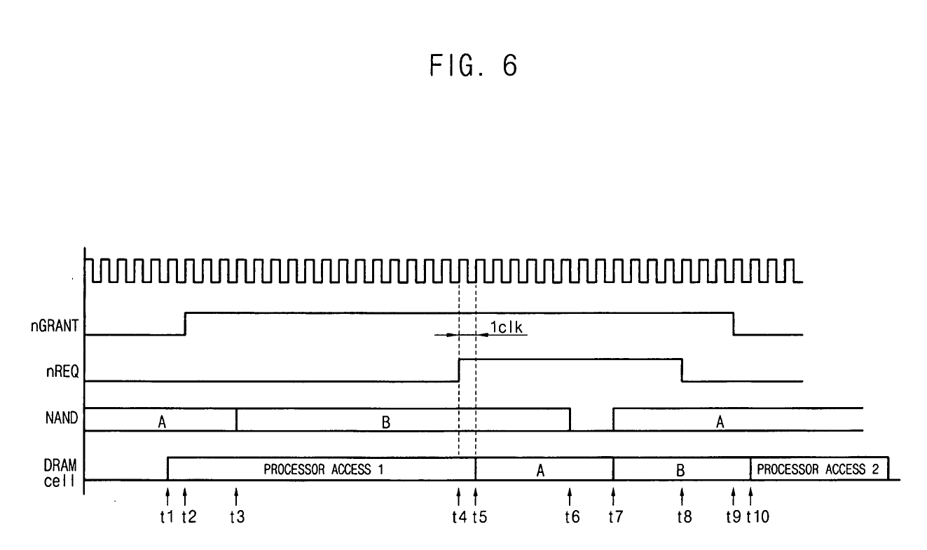

FIG. 6 is a timing diagram showing a plurality of signals of the direct memory access controller DMAC 320 in FIG. 2A, illustrating arbitration methods for alternately accessing the system memory 222 from the processor and from the DMAC 320. The timing diagram of FIG. 6 illustrates an exemplary sequence of alternating accesses of the memory by the processor and by the DMAC 320. In particular, FIG. 6 illustrates a first processor access (PROCESSOR ACCESS 1) beginning at time t1, followed immediately by a transmission of data from buffer A in the DMAC 320 beginning at time t5, followed immediately by a transmission of data from buffer B in the DMAC 320 beginning at time t7, followed immediately by a second processor access (PROCESSOR ACCESS 2) beginning at time t10.

As Illustrated in FIG. 6, the processor has a priority for accessing the memory 222, and so even while (e.g., at time t3 to time t4) buffer A in the DMAC 320 is filled (with “NAND” NVM data) and is ready to be transmitted to the memory 222, that transmission (of buffer A data ) waits until PROCESSOR ACCESS 1 is completed and until after the processor changes the nREQ signal to an inactive state (“High”) (at time t4). PROCESSOR ACCESS 1 commenced (at time t1) while both the nGRANT signal from the DMAC was active (“Low”) and the nREQ signal from the processor was active (“Low”). Thus, only after nREQ is inactive (“High”) (e.g., at time t4) can the internal transfer (of NVM data A and B) to the memory 222 be started (e.g., at time t5).

As further Illustrated in FIG. 6, buffer A is not refilled with data (from the NAND NVM 230) until the data previously stored in buffer A has been completely transmitted to the memory 222 (e.g., not until time t7). But, while (beginning at time t7) buffer A is being be refilled with more “NAND” data from the NVM 230, the data stored in buffer B (since time t6) is being transmitted to the memory 222.

While data stored in buffer B (since time t6) is being transmitted to the memory 222, the nREQ signal from the processor goes active (“Low”) at time t8 yet, the second processor access PROCESSOR ACCESS 2 does not commence until after the transmission of data stored in buffer B has completed, thus storing the B data into the memory 222 (e.g., not until time t10). At time t8, the processor again wants to access the memory 222, but must wait until nGRANT is active (“Low”) at t9. This is due to the Arbiter 322 not asserting nGRANT signal active (“Low”) until the transmission of data stored in buffer B has had the full period (e.g., TB) of time needed to complete the transmission (e.g., not until time t9 following t7 by period TB).

In general, while the processor 210 accesses the memory 222 (e.g., time t1 to t5), the NVM 230 sends data to the buffers A and B in the register 324 of the DMAC 320. If the data (A, B) from the NVM is needed to be sent to the memory 222, when the request signal (nREQ) is changed to an inactive (“High”) state, the data (A, B) buffered in the register 324 are transmitted to the memory 222 one clock period after the changing to an inactive (“High”) state of the nREQ signal (e.g., beginning at time t5). If the processor 210 needs to access the memory 222, the processor 210 sends an active (“Low”) request signal nREQ to the arbiter 322 (e.g., at time t8) and the arbiter 322 decides when to send an active (“Low”) grant signal nGRANT to the processor 210 (e.g., at time t9, giving a full time of TB for the transmission of NAND data B to finish), whereupon, data transmission from the register 324 of the DMAC 320 to the memory 222 is stopped and the processor 210 accesses the memory 222 (at time t10).

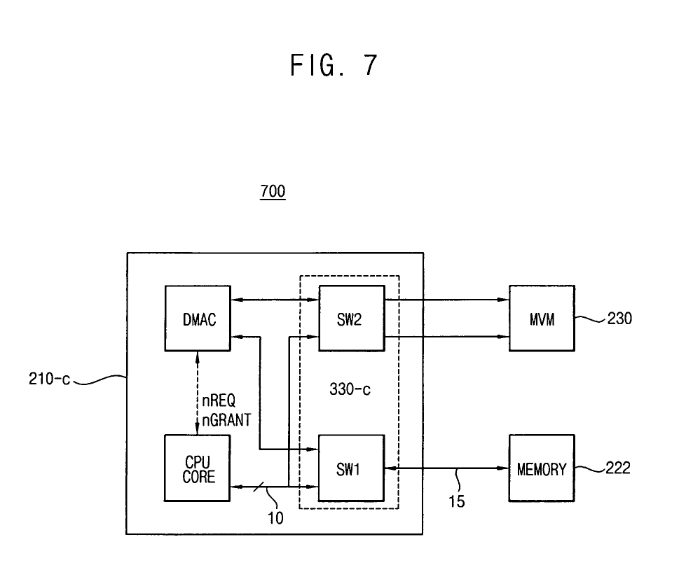

FIG. 7 is a circuit block diagram illustrating a processor system 700 including a processor 210-C having a CPU Core and a direct memory access controller (DMAC 320), switchably connected (by a bus router 330-C) to a system memory (RAM 222) and to a non volatile memory (NVM 230), according to another embodiment of the present invention. The Bus Router 330-C comprises at least one bus switch (e.g., SW1) configured to alternately connect and isolate the bus 15 of the memory 222 from the system bus 10 of the processor CPU Core. The system bus 10 of the processor CPU Core may be operatively disconnected from the bus 15 of the memory 222, e.g., during DMA data transfers performed by the DMAC 320. Alternately, the system bus 10 of the processor CPU Core may be operatively connected to the bus 15 of the memory 222, e.g., during random access of the system memory 222 by the processor CPU Core, (or during a DMA access of the memory 222 performed by the DMAC 320).

The Bus Router 330-C shown in FIG. 7 includes two bus switches SW1 and SW2, each of which includes at least the functionality of a bidirectional bus multiplexer (e.g., a gang of double pole switches or the semiconductor equivalent). Each of bus switches SW1 and SW2 is operatively connected to both the processor CPU Core and the DMAC 320. A first pole (a parallel gang of poles) of each of bus switches SW1 and SW2 is operatively connected to the bus 10 of the processor CPU Core. A second pole (a parallel gang of poles) of each of switch SW1 and SW2 is operatively connected to the bus of DMAC 320. A third pole (a parallel gang of poles) of the first bus switch SW1 is operatively connected to the bus 15 of the system memory (RAM 222). A third pole (a parallel gang of poles) of the second bus switch SW2 is operatively connected the bus of the non volatile memory (NVM 230).

During a DMA data transfer performed by the DMAC 320 between the non volatile memory (NVM 230) and the system memory (RAM 222), bus switches SW1 and SW2 may be configured to disconnect (isolate) the system bus 10 of the processor CPU core from the bus 15 of the memory (RAM 222) and from the bus of the non volatile memory (NVM 230). During the DMA data transfer performed by the DMAC 320 between the non volatile memory (NVM 230) and the system memory (RAM 222), bus switch SW1 will be configured to operatively connect a first bus of the DMAC to the bus 15 of the memory (RAM 222); and bus switch SW2 will be configured to operatively connect a second bus of the DMAC to the bus of the non volatile memory (NVM 230). In this manner, a DMA transfer of data between the NVM and the memory (RAM 222), or vice versa, may be performed without using or tying up the system bus 10 of the processor CPU Core.

During a random access by the processor CPU Core of the system memory 222, the first bus switch SW1 will bus switch SW1 will be configured to operatively connect system bus 10 of the processor CPU Core to the bus 15 of the memory (RAM 222); and, the second bus switch SW2 may be configured to disconnect the system bus 10 of the processor CPU Core from the bus of the non volatile memory (NVM 230).

In some embodiments of the invention, at least one of the first bus switch SW1 and the second bus switch SW2 will be configurable to operatively connect the system bus 10 of the processor CPU Core to a bus (e.g., a first bus or second bus) of the DMAC 320. For example, the first bus switch SW1 may operatively connect the CPU Core with the DMAC 320, and meanwhile, the second bus switch SW2 may operatively connect the DMAC 320 with the non volatile memory (NVM 230). Such a configuration of the switches SW1 and SW2 in the Bus Router 330-C would support data transfer between the CPU Core and the non volatile memory NVM 230 (through the DMAC 320).

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A memory device, comprising:
a RAM;
a memory access controller (DMAC) having a first data path and a second data path, the first data path is connected to access the RAM, the second data path is connected to access an external nonvolatile memory; and
a third data path that is connected to access the RAM by an external processor.

2. The memory device of claim 1, further including a first control path that facilitates transfer of control data between the DMAC and the processor.

3. The memory device of claim 1, further including an arbiter that arbitrates access to the RAM or access to the nonvolatile memory.

4. The memory device of claim 1, wherein the DMAC includes a buffer that buffers data accessed from the RAM or the nonvolatile memory.

5. The memory device of claim 1, further including a multiplexer that multiplexes access to the RAM between the first data path and the third data path.

6. The memory device of claim 1, further including a register for latching data from the processor.

7. The memory device of claim 1, further including a first interface that interfaces between the DMAC and the nonvolatile memory and a second interface that interfaces between the DMAC and the RAM.

8. The memory device of claim 7, wherein a data path between the nonvolatile memory and the RAM is defined by the first interface, the buffer, and the second interface.

9. The memory device of claim 1, wherein data accessed from the nonvolatile memory is retrieved by the processor through the third data path.

10. The memory device of claim 1, further including an input/output buffer that buffers input and output data from and to the processor.

11. The memory device of claim 1, wherein the RAM is one of an DRAM and an SRAM.

12. The memory device of claim 1, wherein the nonvolatile memory is a flash memory.

13. An apparatus comprising a processor, a RAM, a direct memory access controller (DMAC), and a nonvolatile memory, wherein the DMAC controls data access from the RAM to the processor through a first data path and data access from the nonvolatile memory to the processor through the first data path.

14. The apparatus of claim 13, wherein the DMAC and the RAM are disposed within a RAM device.

15. The apparatus of claim 14, further including a first control path that facilitates transfer of control data between the DMAC and the processor.

16. The apparatus of claim 14, further including an arbiter that arbitrates access to the RAM or to the nonvolatile memory.

17. The apparatus of claim 14, wherein the DMAC includes a buffer that buffers data accessed from the RAM or the nonvolatile memory.

18. The apparatus of claim 14, further including a multiplexer that multiplexes access to the RAM between the first data path and a second data path.

19. The apparatus of claim 14, further including a first interface that interfaces between the DMAC and the nonvolatile memory and a second interface that interfaces between the DMAC and RAM.

20. The apparatus of claim 19, wherein a data path between the nonvolatile memory and the RAM is defined by the first interface, the buffer, and the second interface.

21. The apparatus of claim 14, wherein data accessed from the nonvolatile memory is retrieved by the processor through the RAM.

22. The apparatus of claim 14, further including an input/output buffer that buffers input and output data from and to the processor.

23. The apparatus of claim 14, wherein the RAM is one of a DRAM and an SRAM.

24. The apparatus of claim 14, wherein the nonvolatile memory is a flash memory.

25. A method of accessing memory in an apparatus having a processor, a RAM, a direct memory access controller (DMAC), and a nonvolatile memory, the method comprising controlling data access with the DMAC to access data from the RAM to the processor through a first data path and data access from the nonvolatile memory to the processor through the first data path.

26. The method of claim 25, wherein the DMAC and the RAM are disposed within a RAM device.

27. The method of claim 26, further including arbitrating with an arbiter access to the RAM or to the nonvolatile memory.

28. The method of claim 25, further including buffering with a buffer data accessed from the RAM or the nonvolatile memory.

29. The method of claim 25, further including multiplexing with a multiplexer access to the RAM between the first data path and a second data path.

30. The method of claim 25, further including interfacing with a first interface the DMAC and the nonvolatile memory and interfacing with a second interface between the DMAC and RAM.

31. The method of claim 30, further including defining a data path between the nonvolatile memory and the RAM by the first interface, the buffer, and the second interface.

32. The method of claim 25, wherein data accessed from the nonvolatile memory is stored in the RAM and the data is retrieved by the processor from the RAM.

33. The method of claim 25, further including buffering with a buffer input and output data from and to the processor.

34. The method of claim 25, wherein the RAM is one of a DRAM and an SRAM.

35. The method of claim 25, wherein the nonvolatile memory is a flash memory.

36. A memory device, comprising:
a memory;
a direct memory access controller (DMAC);
an internal bus between the memory and the DMAC; and,
a bus multiplexer;
wherein the bus multiplexer alternately establishes a first data transmission path over a system bus between the memory and an external processor, and a second data transmission path over the internal bus between the memory and the DMAC.

37. A processor system, comprising:
a CPU Core;
a system bus of the CPU Core;
a direct memory access controller (DMAC); and
a first bus switch connected to the system bus for alternately establishing a first data transmission path between an external memory and the CPU core, and a second data transmission path between the memory and the DMAC.

38. The processor system of claim 37, wherein the first data transmission path supports a random access, by the CPU Core, of the memory.

39. The processor system of claim 37, wherein the second data transmission path supports a direct memory access, performed by the DMAC, of the memory.

40. The processor system of claim 37, wherein the first bus switch is further adapted to establish a third data transmission path supporting a transfer of data between the CPU Core and the DMAC.

41. The processor system of claim 40, wherein the third data transmission path includes system bus of the CPU Core.

42. The processor system of claim 40, wherein the third data transmission path supports a transfer of data between a non volatile memory (NVM) and the CPU core.
